(19) United States
(12) Patent Application Publication
(10) Pub. No.: US 2016/0286608 A1
(43) Pub. Date: Sep. 29, 2016

(54) Portable Defrosting Unit for Vehicle Windshields and Method Therefore

(71) Applicant: Jonathan Maughan, Holladay, UT (US)

(72) Inventor: Jonathan Maughan, Holladay, UT (US)

(21) Appl. No.: 15/062,102

(22) Filed: Mar. 5, 2016

Related U.S. Application Data
(60) Provisional application No. 62/138,467, filed on Mar. 26, 2015.

(51) Int. Cl. H05B 1/02; H05B 3/84; H05B 3/36

(52) U.S. Cl. CPC H05B 1/0236; H05B 1/0202; H05B 3/36; H05B 3/84

(57) ABSTRACT

A pad containing resistive heating elements and method of use to defrost a windshield are disclosed. In the preferred embodiment, the pad comprises a connection to a power source, a transceiver, a memory unit, a microprocessor, and an internal temperature sensor. The method of use comprises removably securing the pad to the internal surface of the windshield of the car by an attachment means. The pad may be set to automatically activate the heating elements when the outside temperature falls below a certain temperature or at a specific time. The user may remotely program the operation of the pad by a computer. The pad may also record information concerning the operation of the pad and transmit the information to the user.

### PRIORITY

This application claims priority to U.S. Provisional Patent Application Ser. No. 62/138,467 filed Mar. 26, 2015.

### FIELD OF INVENTION

The invention is pertains generally to automotive components and more specifically to an electric heating device for defrosting windows of a motor vehicle.

### BACKGROUND OF INVENTION

There are millions of cars within the United States. A great number of these cars are parked outside or otherwise exposed to the elements. In northern climates this can present an irritation to drivers during the winter months. When temperatures drop to freezing or below, car windshields tend to frost over. The frost forms a thin sheet of ice on the windshield. This sheet of ice can be thin or thick. At times of extreme temperatures, frost can even form on the internal surface of the windshield. Drivers can remove the frost with a scraper. But scrapers are only configured to scrape the external surface of the windshield. Also, some drivers may lack the strength to properly scrape a windshield or be required to scrape the windshield in dangerous conditions.

Some cars have the capability of remote start, where the car can start while the driver remains inside a building. This melts the frost on the windshield without the driver being present. Once the driver is ready to drive the vehicle then the frost is melted and the driver can proceed to driving without scraping the windshield. However, not all vehicles have this feature. Also, the vehicles which do have this feature normally require the user to select when to start the vehicle remotely and a user may forget to utilize the feature. What is needed is a device which is portable that a user can place in the windshield of a vehicle to defrost the windshield prior to a user entering it, which starts automatically when needed.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward a method for defrosting the front windshield of a car utilizing a pad having one or more resistive heating elements and a power supply cable connected to a power source. In other embodiments the pad may further comprise a microprocessor, a nonvolatile memory unit, a temperature sensor, and/or a transceiver. The inventive method comprises placing a pad adjacent to a windshield of a car within an internal space of the car, removably securing the pad to the internal surface of the windshield of the car via an attachment means, supplying power to the one or more resistive heating elements to cause an increase the temperature of the pad, and causing sufficient heat to transfer from the pad to the windshield to melt ice disposed on an external surface of the windshield. In another embodiment the step of removably securing the pad comprises attaching a plurality of pad holders to an internal surface of the windshield of the car and removably securing the pad to the plurality of pad holders.

The method may further comprise receiving a temperature reading from the sensor, setting a predetermined temperature for the activation of the one more heating elements of the pad, saving, by the nonvolatile memory unit, the predetermined temperature, determining, by the microprocessor, when the temperature reading is equal to or below the predetermined temperature, and activating, by the microprocessor, the one or more heating elements when the temperature reading is equal to or below the temperature reading.

The method may further comprise receiving, by the transceiver, a temperature reading from a temperature sensor located external from the car communicatively coupled to the pad, setting a predetermined temperature for the activation of the one more heating elements of the pad, saving, by the nonvolatile memory unit, the predetermined temperature, determining, by the microprocessor, when the temperature reading is equal to or below the predetermined temperature, and activating, by the microprocessor, the one or more heating elements when the temperature is equal to or below the temperature.

The method may further comprise establishing a predetermined time for the activation of the one or more heating elements, storing the predetermined time in the nonvolatile memory unit, determining, by the microprocessor, a local current time, determining, by the microprocessor, when the local current time is equal to the predetermined time, and activating, by the microprocessor, the one or more heating elements when the local current time is equal to the predetermined time.

The method may further comprise determining, by the processor, a set of information related to the operation of the pad, the set of information selected from a group consisting of: a power consumption amount by the pad at any given moment, an average power consumption amount by the pad, an amount of power remaining in a power source connected to the pad, and amount of time the one or more heating elements are activated, storing, by the nonvolatile memory unit, the set of information related to the operation of the pad, and transmitting, via the transceiver, the set of information related to the operation of the pad to a client computer.

In another embodiment the pad further comprises a metallic foil disposed on one side of the pad and the method further comprises placing the metallic foil against an internal surface of the windshield.

In another embodiment the pad further comprises an insulating material disposed on one side of the pad and the method further comprises placing the side having the insulating material away from the internal surface of the windshield.

The method may further comprise receiving, at a client computer, instructions regarding the operations of the pad, transmitting the instructions from the computer to the pad, receiving, by the transceiver, the instructions, storing the instructions in the nonvolatile memory unit, and executing, by the microprocessor, the instructions.

In another embodiment of the invention the method for defrosting the front windshield of a car comprises placing a pad adjacent to a windshield of a car within an internal space of the car, folding the pad into a folded configuration, standing the pad in a vertical position on an edge of the pad, placing the pad on a dashboard or the car, supplying power to the one or more resistive heating elements to cause an increase the temperature of the pad, and causing sufficient heat to transfer from the pad to the windshield to melt ice disposed on an external surface of the windshield.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic view of the heating system.

FIG. 2 is a front perspective view of a car.

FIG. 3 is a side partial view of an internal area of a car.

FIG. 4 is a top partial view of a dashboard of a car.

FIG. 5 is a front view of a windshield.

FIG. 6 is a front view of a windshield.

FIG. 7 is a diagram of a computer report.

FIG. 8 is a schematic illustrating the method of the invention.

FIG. 9 is a schematic illustrating the method of the invention.

FIG. 10 is a schematic illustrating the method of the invention.

FIG. 11 is a schematic illustrating the method of the invention.

FIG. 12 is a schematic illustrating the method of the invention.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

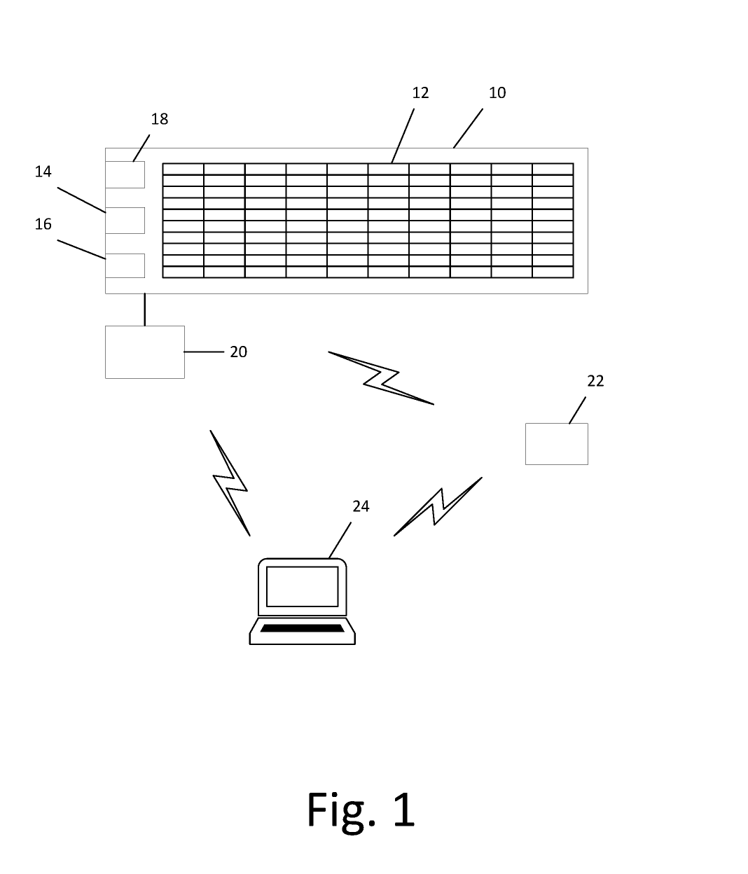

The invention is directed toward a device and method for automatically defrosting the windshield of a vehicle. Referring to FIG. 1, the device comprises a pad 10 incorporating one or more heating elements 12. The pad 10 is configured to be placed against the windshield of the vehicle. The heating elements 12 generate heat to warm the pad 10 and melt any frost on the windshield. The heating elements 12 can be incorporated into the pad 10 in any manner. In the preferred embodiment, the heating elements 12 are configured in a grid shape throughout the pad 10 to ensure the greatest surface area of the pad 10 is capable of heating the windshield. The pad 10 may be of any size, shape, and thickness. In the preferred embodiment the pad 10 is substantially rectangular in shape to match the shape of the windshield. The pad 10 may be in a folded accordion-shape permitting the pad to stand on its edge. The heating elements 12 may be any type of components capable of generating heat. In the preferred embodiment the heating elements 12 are resistive electrical wires. The heating elements 12 may be comprised of a wire mesh. In another embodiment the heating elements 12 may be composed of one or more plates or panels.

The pad 10 may be composed of any type of material and may be composed of different layers of different types of material. For instance, the pad 10 may be composed of a metallic foil surrounding the heating elements 12, or some other heat conductive material. Alternatively, the pad 10 may be composed of a cotton fiber or other insulating material surrounding the heating elements 12 to prevent overheating the outer surface of the pad 10 or prevent burns to users. Alternatively, the pad 10 may be composed of a combination of conductive and insulating materials.

In another embodiment the pad 10 may contain an attachment means. The attachment means may be any type of structure or component which removably secures the pad 10 to the internal surface of the windshield. The attachment means may be tape to adhere the pad 10 to the windshield. The attachment means may be segments of hook and loop tape which can be secured to the fabric covering the internal surface of the roof of the vehicle. In some embodiments the size of the pad 10 may be large enough, and the pad 10 may be inflexible enough, such that the pad 10 is physically compressed against the windshield and is held in place by the structural integrity of the pad 10 itself. The attachment means may also be one or more suction cups, bungee cords, or string segments.

In another embodiment the pad 10 further comprises a processor unit 14 and an internal sensor 16. The processor unit 14 is a master control unit and may comprise an internal memory for storing instructions and a processor for executing instructions. The processor unit 14 may be further comprised of a clock or timer component. The internal sensor 16 is configured to detect the temperature of the windshield. The processor unit 14 is configured to be programmed to activate the heating elements 12 when the internal sensor 16 measures a temperature reading below a predetermined temperature. For instance, if the internal sensor 16 measures a temperature of thirty-two degrees then the processor unit 14 activates the heating elements 12. The processor unit 14 may be programmed to activate the heating elements 12 for a predetermined amount of time, or alternatively, until the internal sensor 16 measures a predetermined temperature which is above the freezing point.

In another embodiment, the pad 10 further comprises a power source 20. The power source 20 is any component which provides electrical energy to the pad 10 to allow the heating elements 12 to generate heat. The power source 20 may be a battery or battery pack. Alternatively, the power source 20 may be a connection cord which connects the pad 10 to the battery of the vehicle. In another embodiment, the power source 20 may be a solar panel connected to the surface of the pad 10.

In another embodiment, the pad 10 further comprises a transceiver 18. The transceiver 18 can be communicatively coupled to an external sensor 22. The external sensor 22 is configured to measure the ambient air temperature outside of the vehicle. Alternatively, the external sensor 22 may be configured to measure the temperature of the external surface of the windshield. The processor unit 14 can be configured to activate the heating elements 12 when the external sensor 22 measures a temperature below a predetermined temperature.

In another embodiment, the transceiver 18 and external sensor 22 may be communicatively coupled to a client computer 24. The client computer 24 may be any web-enabled, computerized electronic device, such as a desktop computer, a laptop computer, a tablet computer, or a web-enabled cell phone. The client computer 24 permits a user to configure the operation of the pad 10. The user may insert instructions into a user interface on the client computer 24 which are wirelessly transferred to the processor unit 14. For instance, the user may use the client computer 24 to set the pad 10 to automatically activate the heating elements 12 at a specific time of day. Alternatively, the user may use the client computer 24 to modify and establish a predetermined temperature measured by either the internal sensor 16, the external sensor 22, or both, at which the processor unit 14 is configured to activate the heating elements 12. The client computer 24 may be utilized to track information on the activation time of the heating elements 12, power consumption by the heating elements 12, reserve charge left in the power source 20, or any other information relevant to the operation of the pad 10. Alternatively, the user interface of the client computer 24 may be utilized to automatically connect to, and download relevant information from, local or national weather centers. This information can include weather forecasts and average temperature information. The information obtained from these sources may be utilized to automatically configure the processor unit 14 to activate the heating elements 12 based on the information received.

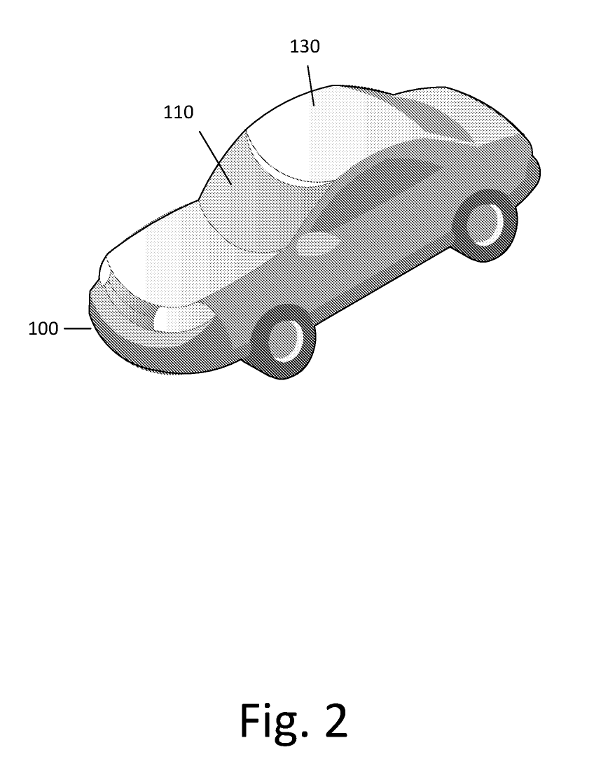

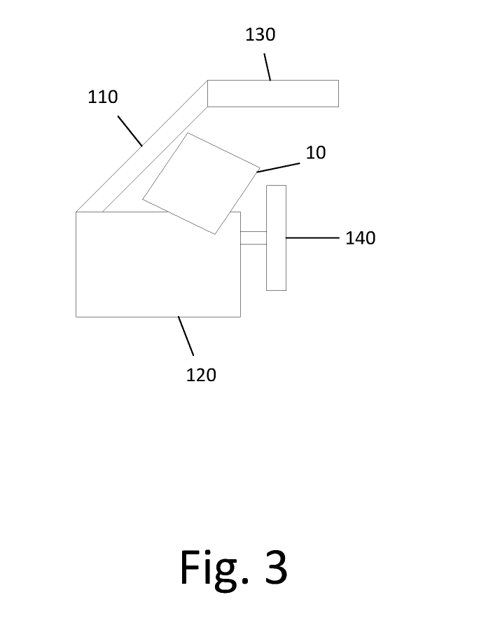

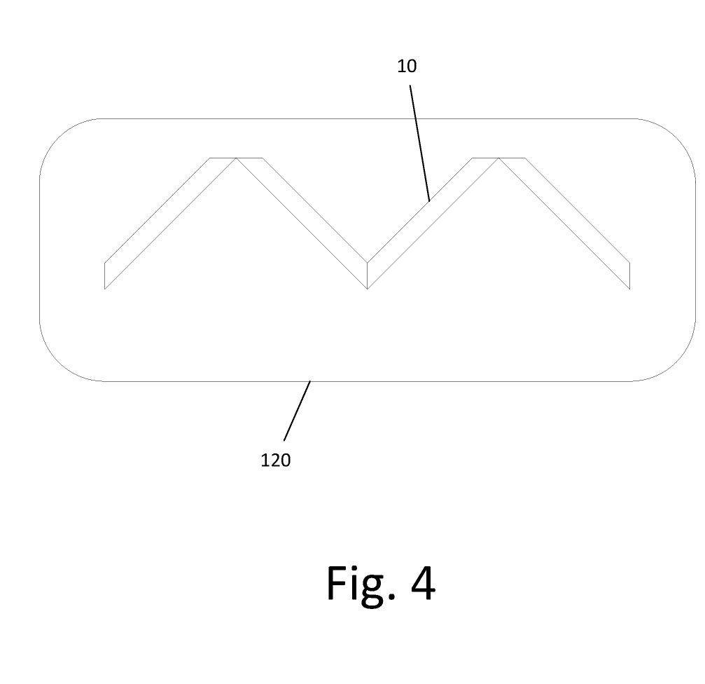

Referring to FIG. 2, the invention is best utilized in a car 100. The car 100 comprises a windshield 110 disposed on the front portion of the car and a roof 130. Referring to FIG. 3 and FIG. 4, the pad 10 can be folded into a folded configuration and stood up on the dashboard 120 of the car 100. The pad 100 is placed adjacent to the windshield 110, which is connected to the roof 130. In the preferred embodiment the pad 10 is placed wholly on the dashboard 120 behind the steering wheel 140.

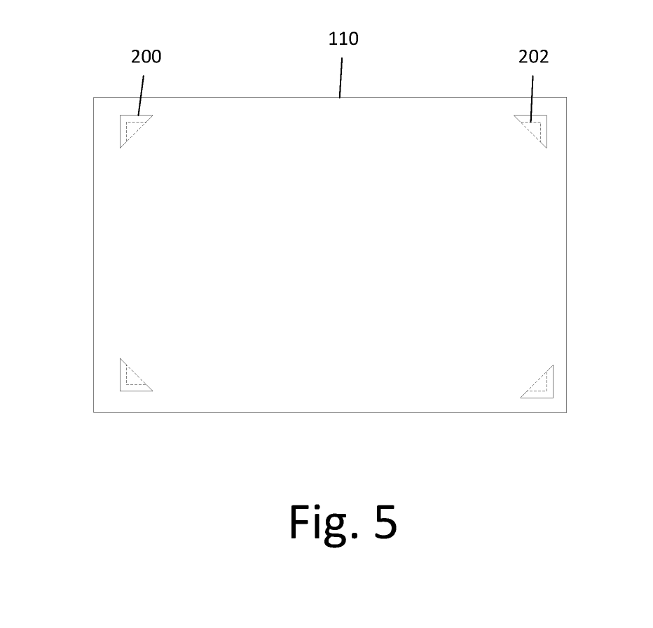

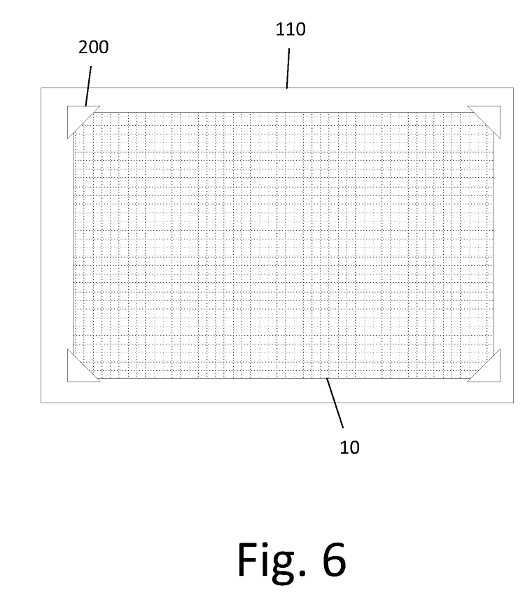

Referring to FIG. 5 and FIG. 6, the pad 10 may be directly mounted on the interior surface of the windshield 110. To mount the pad 10, the user places a plurality of pad holders 200 onto the windshield 110. The pad holders 200 may each have a pocket 202 which holds a portion of the pad 10. A user places a portion of the pad 10 in each pocket 202 to hold the pad 10 against the windshield 110. Once the ice is defrosted the user then removes the pad 10 from the pad holders 200. The pad holders 200 are removably secured to the windshield 110 by an adhesive and remain on the windshield while the car 100 is in use. In other embodiments the pad holders 200 have hook and loop tape on the outer surface. The pad 10 is secured to the hook and loop tape to hold the pad against the windshield 110.

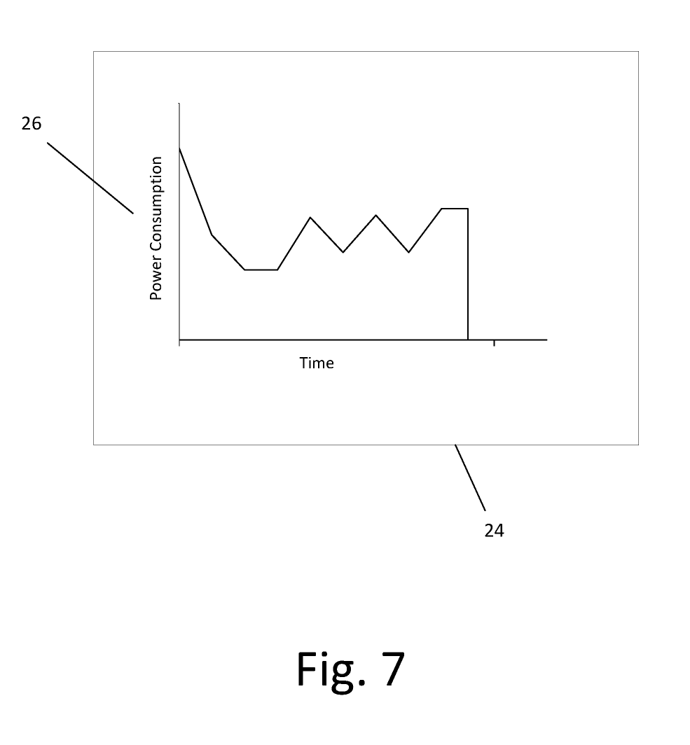

Referring to FIG. 7, the operation of the pad 10 can be monitored by the microprocessor 14 and recorded data can be transferred to the client computer 24 by the transceiver 18. As shown in FIG. 7 the client computer 24 displays a graph 26 showing the power consumption over time. The graph 26 may display any type of information regarding the use of the pad 10, including but limited to average power consumption, times when the heating elements are activated, the amount of charge left in a power supply connected to the pad, or any other relevant information.

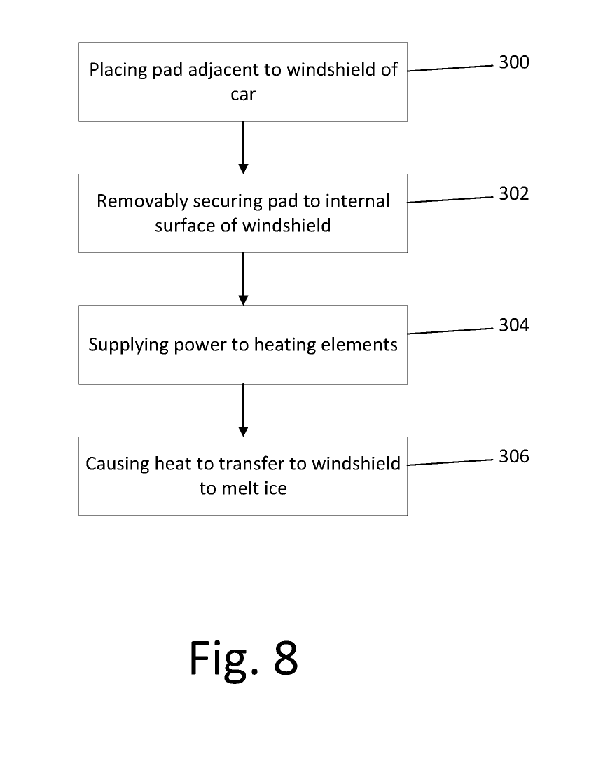

Referring to FIG. 8 through FIG. 12, the method of the invention if illustrated. First a user places the pad adjacent to the windshield of the car 300. The user then removably secures the pad to the internal surface of the windshield 302. The power supply then supplies power to the heating elements when the pad is turned on or activated 304. The user activates the heating elements to cause the heat to transfer to the windshield to melt ice on the windshield 306.

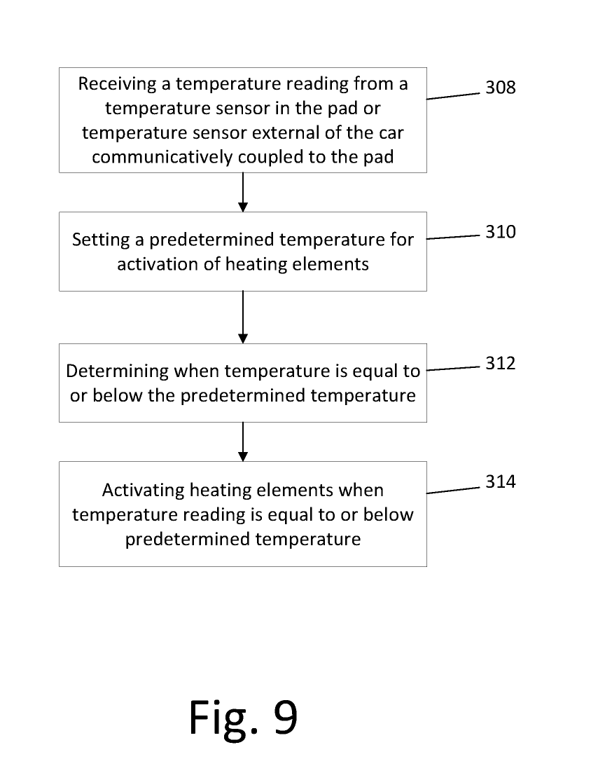

As shown in FIG. 9, the pad can receive a temperature from a temperature sensor in the pad or an external temperature sensor communicatively coupled to the pad 308. The user then sets a predetermined temperature for the activation of the heating elements 310. The microprocessor determines when the temperature reading is equal to or below the predetermined temperature 312. The microprocessor then activates the heating elements when the temperature reading is equal to or below the predetermined temperature 314.

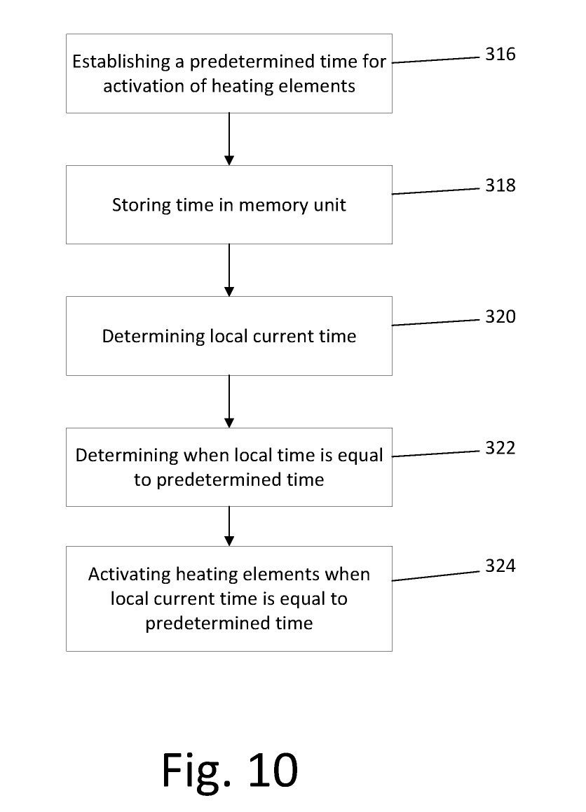

As shown in FIG. 10, the user can establish a predetermined time for the activation of the heating elements 316. The memory unit stores the predetermined time 318. The microprocessor determines a local current time 320. The local current time can be preprogrammed into the memory unit of the pad or the pad may intermittently receive the local current time via the internet by its transceiver. The microprocessor determines when the local tie is equal to the predetermined time 322. The microprocessor then activates the heating elements when the local current time is equal to the predetermined time 324.

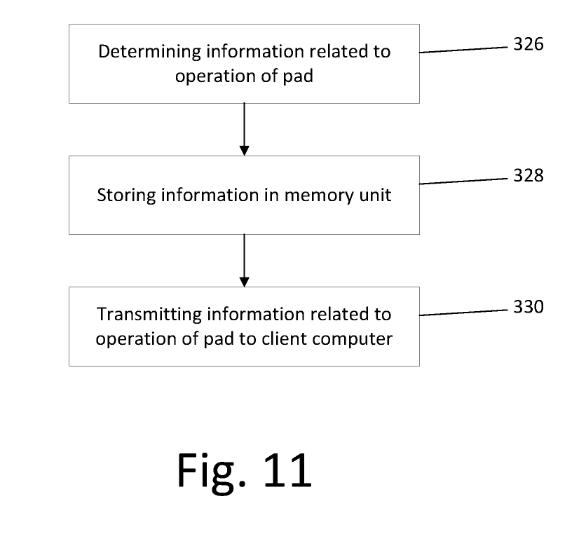

As shown in FIG. 11, the microprocessor can determine a set of information related to the operation of the pad 326. The information related to the operation of the pad is then stored on the memory unit 328. The pad then transmits the information by the transceiver to a client computer 330.

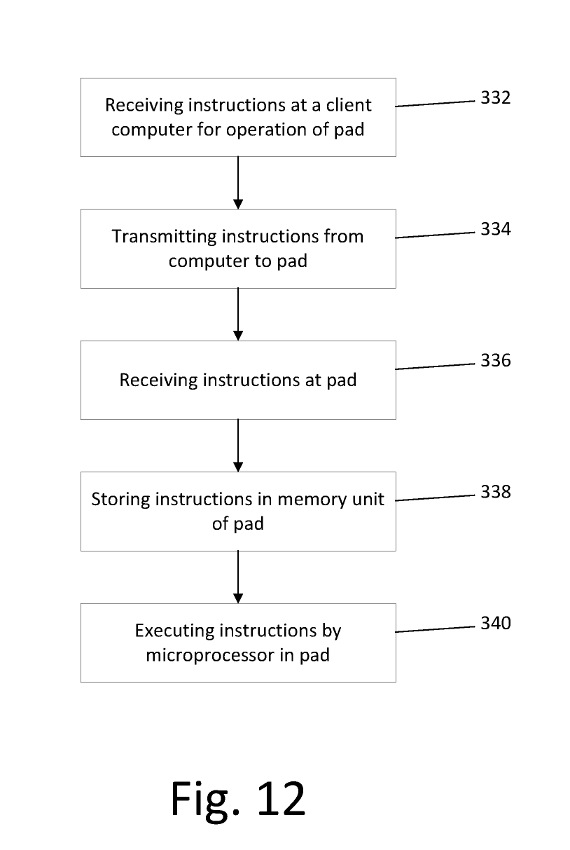

As shown in FIG. 12, the client computer can receive instructions for the operation of the pad 332. The set of instructions are a set of computer code instructions which can be executed by the microprocessor 14 to alter the operation of the pad 10 as desired by the user. The client computer then transmits the instructions to the pad 334. The pad receives the instructions 336. The pad stores the instructions in the memory unit of the pad 338. The microprocessor executes the instructions to alter the operation of the pad 340.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) A method for defrosting the front windshield of a car comprising
a) placing a pad adjacent to a windshield of a car within an internal space of said car
i) said pad comprising one or more resistive heating elements and a power supply cable connected to a power source;
b) removably securing said pad to said internal surface of said windshield of said car via an attachment means;
c) supplying power to said one or more resistive heating elements to cause an increase the temperature of said pad;
d) causing sufficient heat to transfer from said pad to said windshield to melt ice disposed on an external surface of said windshield.

2) The method as in claim 1 wherein removably securing said pad comprises
a) attaching a plurality of pad holders to an internal surface of said windshield of said car;
b) removably securing said pad to said plurality of pad holders.

3) The method as in claim 2, wherein said pad further comprises a temperature sensor, a microprocessor, and a nonvolatile memory unit, said method further comprising
a) receiving a temperature reading from said sensor;
b) setting a predetermined temperature for the activation of said one more heating elements of said pad;
c) saving, by said nonvolatile memory unit, said predetermined temperature;
d) determining, by said microprocessor, when said temperature reading is equal to or below said predetermined temperature;
e) activating, by said microprocessor, said one or more heating elements when said temperature reading is equal to or below said temperature reading.

4) The method as in claim 2, wherein said pad further comprises a transceiver, a microprocessor, and a nonvolatile memory unit, said method further comprising
a) receiving, by said transceiver, a temperature reading from a temperature sensor located external from said car communicatively coupled to said pad;
b) setting a predetermined temperature for the activation of said one more heating elements of said pad;
c) saving, by said nonvolatile memory unit, said predetermined temperature;
d) determining, by said microprocessor, when said temperature reading is equal to or below said predetermined temperature;
e) activating, by said microprocessor, said one or more heating elements when said temperature is equal to or below said temperature.

5) The method as in claim 2, wherein said pad further comprises a microprocessor and a nonvolatile memory unit, said method further comprising
a) establishing a predetermined time for the activation of said one or more heating elements;
b) storing said predetermined time in said nonvolatile memory unit;
c) determining, by said microprocessor, a local current time;
d) determining, by said microprocessor, when said local current time is equal to said predetermined time;
e) activating, by said microprocessor, said one or more heating elements when said local current time is equal to said predetermined time.

6) The method as in claim 2, wherein said pad further comprises a transceiver, a microprocessor, and a nonvolatile memory unit, said method further comprising
a) determining, by said processor, a set of information related to the operation of said pad, said set of information selected from a group consisting of: a power consumption amount by said pad at any given moment, an average power consumption amount by said pad, an amount of power remaining in a power source connected to said pad, and amount of time said one or more heating elements are activated;
b) storing, by said nonvolatile memory unit, said set of information related to the operation of said pad;
c) transmitting, via said transceiver, said set of information related to the operation of said pad to a client computer.

7) The method as in claim 2 wherein said pad further comprises a metallic foil disposed on one side of the pad, the method further comprising placing said metallic foil against an internal surface of said windshield.

8) The method as in claim 2 wherein said pad further comprises an insulating material disposed on one side of the pad, the method further comprising placing said side having said insulating material away from said internal surface of said windshield.

9) The method as in claim 2, wherein said pad further comprises a transceiver, a microprocessor, and a nonvolatile memory unit, said method further comprising
a) receiving, at a client computer, instructions regarding the operations of said pad
b) transmitting said instructions from said computer to said pad
c) receiving, by said transceiver, said instructions
d) storing said instructions in said nonvolatile memory unit
e) executing, by said microprocessor, said instructions.

10) The method as in claim 9 further comprising
a) determining, by said processor, a set of information related to the operation of said pad, said set of information selected from a group consisting of: a power consumption amount by said pad at any given moment, an average power consumption amount by said pad, an amount of power remaining in a power source connected to said pad, and amount of time said one or more heating elements are activated;
b) storing, by said nonvolatile memory unit, said set of information related to the operation of said pad;
c) transmitting, via said transceiver, said set of information related to the operation of said pad to a client computer.

11) The method as in claim 10 further comprising
a) establishing a predetermined time for the activation of said one or more heating elements;
b) storing said predetermined time in said nonvolatile memory unit;
c) determining, by said microprocessor, a local current time;
d) determining, by said microprocessor, when said local current time is equal to said predetermined time;
e) activating, by said microprocessor, said one or more heating elements when said local current time is equal to said predetermined time.

12) The method as in claim 11, wherein said pad further comprises a temperature sensor, said method further comprising
a) receiving a temperature reading from said sensor;
b) setting a predetermined temperature for the activation of said one more heating elements of said pad;
c) saving, by said nonvolatile memory unit, said predetermined temperature;
d) determining, by said microprocessor, when said temperature reading is equal to or below said predetermined temperature;
e) activating, by said microprocessor, said one or more heating elements when said temperature reading is equal to or below said temperature reading.

13) The method as in claim 11 further comprising
a) receiving, by said transceiver, a temperature reading from a temperature sensor located external from said car communicatively coupled to said pad;
b) setting a predetermined temperature for the activation of said one more heating elements of said pad;
c) saving, by said nonvolatile memory unit, said predetermined temperature;
d) determining, by said microprocessor, when said temperature reading is equal to or below said predetermined temperature;
e) activating, by said microprocessor, said one or more heating elements when said temperature is equal to or below said temperature.

14) A method for defrosting the front windshield of a car comprising
a) placing a pad adjacent to a windshield of a car within an internal space of said car
i) said pad comprising one or more resistive heating elements and a power supply cable connected to a power source;
b) folding said pad into a folded configuration;
c) standing said pad in a vertical position on an edge of said pad;
d) placing said pad on a dashboard or said car;
e) supplying power to said one or more resistive heating elements to cause an increase the temperature of said pad;
f) causing sufficient heat to transfer from said pad to said windshield to melt ice disposed on an external surface of said windshield.

15) The method as in claim 14, wherein said pad further comprises a transceiver, a microprocessor, and a nonvolatile memory unit, said method further comprising
a) receiving, at a client computer, instructions regarding the operations of said pad
b) transmitting said instructions from said computer to said pad
c) receiving, by said transceiver, said instructions
d) storing said instructions in said nonvolatile memory unit
e) executing, by said microprocessor, said instructions.

16) The method as in claim 15 further comprising
a) determining, by said processor, a set of information related to the operation of said pad, said set of information selected from a group consisting of: a power consumption amount by said pad at any given moment, an average power consumption amount by said pad, an amount of power remaining in a power source connected to said pad, and amount of time said one or more heating elements are activated;
b) storing, by said nonvolatile memory unit, said set of information related to the operation of said pad;
c) transmitting, via said transceiver, said set of information related to the operation of said pad to a client computer.

17) The method as in claim 16 further comprising
a) establishing a predetermined time for the activation of said one or more heating elements;
b) storing said predetermined time in said nonvolatile memory unit;
c) determining, by said microprocessor, a local current time;
d) determining, by said microprocessor, when said local current time is equal to said predetermined time;
e) activating, by said microprocessor, said one or more heating elements when said local current time is equal to said predetermined time.

18) The method as in claim 17, wherein said pad further comprises a temperature sensor, said method further comprising
a) receiving a temperature reading from said sensor;
b) setting a predetermined temperature for the activation of said one more heating elements of said pad;
c) saving, by said nonvolatile memory unit, said predetermined temperature;
d) determining, by said microprocessor, when said temperature reading is equal to or below said predetermined temperature;
e) activating, by said microprocessor, said one or more heating elements when said temperature reading is equal to or below said temperature reading.

19) The method as in claim 17 further comprising
a) receiving, by said transceiver, a temperature reading from a temperature sensor located external from said car communicatively coupled to said pad;
b) setting a predetermined temperature for the activation of said one more heating elements of said pad;
c) saving, by said nonvolatile memory unit, said predetermined temperature;
d) determining, by said microprocessor, when said temperature reading is equal to or below said predetermined temperature;
e) activating, by said microprocessor, said one or more heating elements when said temperature is equal to or below said temperature.

20) The method as in claim 14 further comprising
a) receiving a temperature reading from said sensor;
b) setting a predetermined temperature for the activation of said one more heating elements of said pad;
c) saving, by said nonvolatile memory unit, said predetermined temperature;
d) determining, by said microprocessor, when said temperature reading is equal to or below said predetermined temperature;
e) activating, by said microprocessor, said one or more heating elements when said temperature reading is equal to or below said temperature reading.
